(19) United States
(12) Patent Application Publication
(10) Pub. No.: US 2023/0088091 A1
(43) Pub. Date: Mar. 23, 2023

(54) CONDUCTIVE POLYESTER LAMINATED STRUCTURE AND CONDUCTIVE PACKAGING MATERIAL

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Yueh-Shin Liu, Taipei City (TW)

(21) Appl. No.: 17/853,880

(22) Filed: Jun. 29, 2022

(30) Foreign Application Priority Data
Sep. 13, 2021 (TW) 110133938

(51) Int. Cl. C08J 5/04; C08K 3/04

(52) U.S. Cl. CPC C08J 5/042; C08K 3/041; C08J 2367/08

(57) ABSTRACT

A conductive polyester laminated structure and a conductive packaging material are provided. The conductive polyester laminated structure includes a main structure supporting layer and two conductive layers. Each of the conductive layers is formed of a conductive polyester composition. The conductive polyester composition includes a polyester base material and a conductive reinforcing material. The conductive reinforcing material includes multiple carbon nanotubes, and the carbon nanotubes are dispersed in the polyester base material. In each carbon nanotube, a length of the carbon nanotube is defined as L, a diameter of the carbon nanotube is defined as D and is between 1 nanometer and 30 nanometers, and an L/D value of the carbon nanotube is between 300 and 2,000. The carbon nanotubes are in contact with each other to form multiple contact points, so that the conductive polyester composition has a surface impedance of not greater than 10⁷ Ω/sq.

### CROSS-REFERENCE TO RELATED PATENT APPLICATION

This application claims the benefit of priority to Taiwan Patent Application No. 110133938, filed on Sep. 13, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester laminated structure, and more particularly to a conductive polyester laminated structure and a conductive packaging material.

### BACKGROUND OF THE DISCLOSURE

In the related art, conductive sheet materials having a need for vacuum forming are predominately formed by polystyrene (PS). With respect to conductive polystyrene, a conductive property of the polystyrene is reinforced by adding a high proportion (e.g., above 10 wt %) of carbon black. However, a high-proportion addition of a filling material is very likely to cause falling of the filling material during a vacuum forming extension process, such that a finished product can be damaged. In addition, due to an insufficient impact strength of the polystyrene, an embrittlement phenomenon often occurs.

### SUMMARY OF THE DISCLOSURE

In response to the above-referenced technical inadequacies, the present disclosure provides a conductive polyester laminated structure and a conductive packaging material.

In one aspect, the present disclosure provides a conductive polyester laminated structure, which includes: a main structure supporting layer and two conductive layers. The main structure supporting layer has two side surfaces located on opposite sides thereof. The two conductive layers are respectively formed on two of the side surfaces of the main structure supporting layer. Each of the conductive layers is formed of a conductive polyester composition. In each of the conductive layers, the conductive polyester composition includes: a polyester base material and a conductive reinforcing material. The conductive reinforcing material includes a plurality of carbon nanotubes, and the plurality of carbon nanotubes are dispersed in the polyester base material. In each of the carbon nanotubes, a length of the carbon nanotube is defined as L, a diameter of the carbon nanotube is defined as D and is between 1 nanometer and 30 nanometers, and an L/D value of the carbon nanotube is between 300 and 2,000. The plurality of carbon nanotubes are in contact with each other to form a plurality of contact points, so that a surface of the conductive layer has a surface impedance of not greater than 10⁷ Ω/sq.

In certain embodiments, the main structure supporting layer is formed of a polymer resin material and configured to provide an overall impact strength of not less than 4.2 KJ/m² for the conductive polyester laminated structure.

In certain embodiments, the polymer resin material is a polyester resin material, the polyester resin material is isophthalic acid (IPA) modified copolyester and has a low degree of crystallinity Based on a total weight of the polyester resin material, a content of the IPA is between 1 wt % and 10 wt %.

In certain embodiments, the main structure supporting layer and the two conductive layers are formed into a conductive polyester sheet material having a sandwich structure by co-extrusion.

In certain embodiments, a thickness of the main structure supporting layer is greater than a thickness of each of the conductive layers and is between 80 micrometers and 1,400 micrometers, and a thickness of each of the conductive layers is between 10 micrometers and 200 micrometers.

In certain embodiments, in each of the carbon nanotubes, the length is between 10 micrometers and 20 micrometers, the diameter is between 5 nanometers and 20 nanometers, and the L/D value is between 1,000 and 2,000.

In certain embodiments, based on a total weight of the conductive polyester composition, a content of the polyester base material is between 70 wt % and 95 wt %, and a content of the conductive reinforcing material is between 1.5 wt % and 10 wt %.

In certain embodiments, the plurality of carbon nanotubes of the conductive reinforcing material are multi-walled carbon nanotubes (MWCNT) having a multi-layer carbon atom structure.

In certain embodiments, the conductive polyester composition further includes: a compatibilizer, configured to assist in dispersing the plurality of carbon nanotubes in the polyester base material. Based on a total weight of the conductive polyester composition, a content of the compatibilizer is between 1.5 wt % and 10 wt %.

In certain embodiments, the plurality of carbon nanotubes of the conductive reinforcing material are at least one material selected from a group consisting of hydroxylated carbon nanotubes and carboxylic carbon nanotubes. The compatibilizer is a polyolefin compatibilizer formed by grafting, modification or copolymerization of glycidyl methacrylate (GMA), or a siloxane compound.

In certain embodiments, the glycidyl methacrylate in the molecular structure of the compatibilizer can carry out a ring cleavage reaction in a mixing process, and an epoxy group in the glycidyl methacrylate can carry out a chemical reaction with a reactive functional group on the surface of the carbon nanotube and/or an ester group in the molecular structure of the polyester base material after the ring cleavage reaction, so that the carbon nanotubes are dispersed in the polyester base material. The reactive functional group on the surface of the carbon nanotube is at least one of an —OH functional group and a —COOH functional group.

In certain embodiments, the plurality of carbon nanotubes of the conductive reinforcing material are at least one material selected from a group consisting of hydroxylated multi-walled carbon nanotubes and carboxylic multi-walled carbon nanotubes.

In certain embodiments, the compatibilizer is at least one material selected from a group consisting of an ethylene-methyl acrylate-glycidyl methacrylate copolymer (E-MA-GMA), polyolefin elastomer-grafted glycidyl methacrylate (POE-g-GMA), polyethylene-grafted glycidyl methacrylate (PE-g-GMA) and a siloxane compound.

In certain embodiments, the conductive polyester composition further includes: an antioxidant and black master batches. Based on a total weight of the conductive polyester composition, a content of the antioxidant is between 0.1 wt % and 1 wt %, and a content of the black master batches is between 1 wt % and 5 wt %.

In certain embodiments, the conductive polyester composition of each of the conductive layers is configured to be subjected to mixing modification of a twin-screw process.

In certain embodiments, the conductive polyester laminated structure is capable of being extended through a vacuum forming process. Before an extension of the conductive polyester laminated structure, the surface of each of the conductive layers has a surface impedance of 10³ Ω/sq to 10⁴ Ω/sq. After a 200% to 400% extension of the conductive polyester laminated structure along an extension direction, the surface of each of the conductive layers has a surface impedance of 10⁴ Ω/sq to 10⁷ Ω/sq.

In another aspect, the present disclosure provides a conductive polyester laminated structure, which includes: a main structure supporting layer and a conductive layer. The main structure supporting layer has two side surfaces that are located on opposite sides thereof. The conductive layer is formed on one of the side surfaces of the main structure supporting layer. The conductive layer is formed of a conductive polyester composition, and the conductive polyester composition includes: a polyester base material and a conductive reinforcing material. The conductive reinforcing material includes a plurality of carbon nanotubes, and the plurality of carbon nanotubes are dispersed in the polyester base material. In each of the carbon nanotubes, a length of the carbon nanotube is defined as L, a diameter of the carbon nanotube is defined as D and is between 1 nanometer and 30 nanometers, and an L/D value of the carbon nanotube is between 300 and 2,000. The plurality of carbon nanotubes are in contact with each other to form a plurality of contact points, so that a surface of the conductive layer has a surface impedance of not greater than 10⁷ Ω/sq.

In yet another aspect, the present disclosure provides a conductive packaging material. The conductive packaging material is formed by extending the aforementioned conductive polyester laminated structure through a vacuum forming process.

Therefore, in the conductive polyester laminated structure and the conductive packaging material provided by the present disclosure, by virtue of “the conductive reinforcing material including a plurality of carbon nanotubes, and the plurality of carbon nanotubes being dispersed in the polyester base material,” “in each of the carbon nanotubes, a length of the carbon nanotube being defined as L, a diameter of the carbon nanotube being defined as D and being between 1 nanometer and 30 nanometers, and an L/D value of the carbon nanotube being between 300 and 2,000,” and “the plurality of carbon nanotubes being in contact with each other to form a plurality of contact points, so that the conductive polyester composition has a surface impedance of not greater than 10⁷ 106 /sq,” the conductive polyester composition can still have a high conductive property with a small addition of the conductive reinforcing material, and the conductive polyester laminated structure can still have a high conductive property after a high-rate extension.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a conductive polyester laminated structure according to a first embodiment of the present disclosure;

FIG. 2 is a schematic diagram of the conductive polyester laminated structure of FIG. 1 after an extension;

FIG. 3 is a schematic diagram of a carbon nanotube in a conductive polyester composition according to one embodiment of the present disclosure; and

FIG. 4 is a schematic diagram of a conductive polyester laminated structure according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

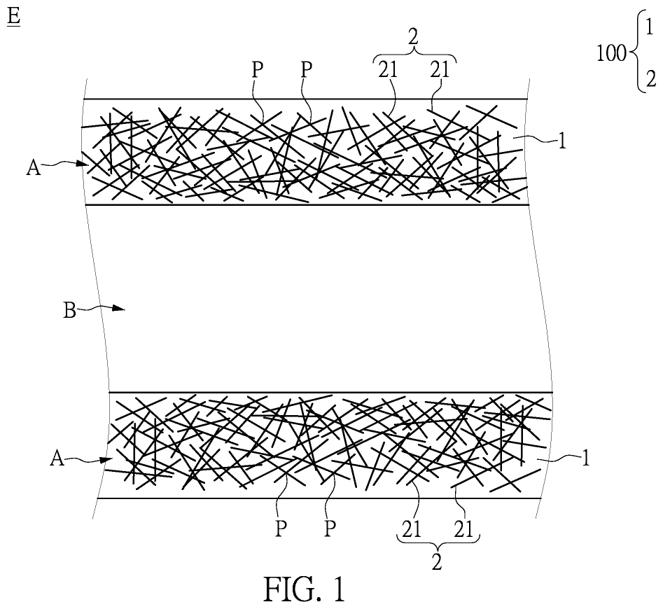

As shown in FIG. 1 to FIG. 3, a first embodiment of the present disclosure provides a conductive polyester laminated structure E. The conductive polyester laminated structure E can be extended through a vacuum forming process, and can still have a high conductive property after an extension. The conductive polyester laminated structure E is a sandwich structure (A-B-A) formed by co-extrusion. The two surface layers A of the sandwich structure are conductive layers with a high conductive property, and the middle layer B of the sandwich structure is a polyester main structure supporting layer having a low degree of crystallinity and capable of providing support.

An objective of the present disclosure is that the conductive polyester laminated structure E can still have a high conductive property after being extended through the vacuum forming process and after a high-rate extension. Accordingly, the conductive polyester laminated structure E can be applied to electronic packaging materials having a need for vacuum forming and conductivity (e.g., electronic carrier trays or electronic carrier tapes).

More specifically, as shown in FIG. 1, the conductive polyester laminated structure E includes a main structure supporting layer B and two conductive layers A. The main structure supporting layer B has two side surfaces (not labeled in the figure) located on opposite sides, and the two conductive layers A are formed on the two side surfaces of the main structure supporting layer B, respectively.

The main structure supporting layer B has a relatively high impact strength, and can provide a good support for the conductive polyester laminated structure E. The main structure supporting layer B is formed of a polymer resin material. Further, the main structure supporting layer B is configured to provide an overall impact strength of not less than 4.2 KJ/m² (preferably not less than 4.5 KJ/m², and more preferably not less than 4.8 KJ/m²) for the conductive polyester laminated structure E.

The polymer resin material can be a resin material having a high impact strength and suitable for ejection forming or extrusion forming (e.g., PET, PE, PP, ABS, PA, PC, POM and PBT). In this embodiment, the polymer resin material is preferably a polyester resin material, and the polyester resin material is isophthalic acid (IPA) modified copolyester and has a low degree of crystallinity. For instance, the polyester resin material has a degree of crystallinity that is not greater than 20% (preferably not greater than 15%, and more preferably not greater than 12%). However, the present disclosure is not limited thereto. In terms of content range, based on a total weight of the conductive polyester composition, a content of the IPA is between 1 wt % and 10 wt %.

Still referring to FIG. 1, the two conductive layers A both have high conductivity, so as to provide high conductivity for the surface layer of the conductive polyester laminated structure E. In this way, the conductive polyester laminated structure E is suitable to be used as an electronic packaging material.

Further, each of the conductive layers A is formed of a conductive polyester composition 100. In each of the conductive layers A, the conductive polyester composition 100 includes: a polyester base material 1 and a conductive reinforcing material 2.

The conductive polyester composition 100 of this embodiment can obtain a high conductive property through selection of a material type of the conductive reinforcing material 2 and adjustment of its content range. Further, after the high-rate extension, the conductive polyester composition 100 of this embodiment can still have a high conductive property.

In this embodiment, the polyester base material 1 is a base material of the conductive polyester composition 100. The polyester base material 1 is a macromolecular polymer obtained by a condensation polymerization reaction between a dibasic acid and a dibasic alcohol or a derivative thereof. That is to say, the polyester base material 1 is a polyester material. Preferably, the polyester material is polyethylene terephthalate (PET) or polyethylene naphthalate (PEN). More preferably, the polyester material is polyethylene terephthalate (PET), but the present disclosure is not limited thereto.

In terms of content range, based on the total weight of the conductive polyester composition 100, a content of the polyester base material 1 is preferably between 70 wt % and 95 wt %, and more preferably between 75 wt % and 95 wt %.

The aforementioned dibasic acid for forming the polyester material is at least one of terephthalic acid, isophthalic acid, 1,5-naphthalic acid, 2,6-naphthalic acid, 1,4-naphthalic acid, diphenic acid, diphenylethane dicarboxylic acid, diphenylsulfone dicarboxylic acid, anthracene-2,6-dicarboxylic acid, 1,3-cyclopentane dicarboxylic acid, 1,3-cyclohexane dicarboxylic acid, 1,4-cyclohexane dicarboxylic acid, malonic acid, dimethylmalonic acid, succinic acid, 3,3-diethyl succinate, glutaric acid, 2,2-dimethylglutaric acid, adipic acid, 2-methyladipic acid, trimethyladipic acid, pimelic acid, azelaic acid, sebacic acid, suberic acid, and dodecanedioic acid.

Further, the aforementioned dibasic alcohol for forming the polyester material is at least one of ethylene glycol, propylene glycol, hexamethylene glycol, neopentyl glycol, 1,2-cyclohexane dimethanol, 1,4-cyclohexane dimethanol, 1,10-decanediol, 1,3-propanediol, 1,4-butanediol, 1,5-pentanediol, 1,6-hexanediol, and 2,2-bis(4-hydroxyphenyl)propane or bis(4-hydroxybenzene) sulfone.

Still referring to FIG. 1, in order to obtain a high conductive property of the conductive polyester composition 100, the conductive reinforcing material 2 includes a plurality of carbon nanotubes 21, and the plurality of carbon nanotubes 21 are uniformly dispersed in the polyester base material 1.

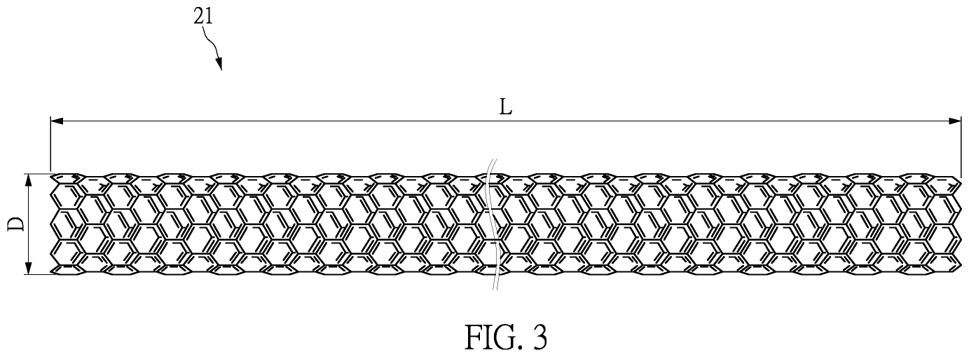

As shown in FIG. 3, in each of the carbon nanotubes 21, a length of the carbon nanotube 21 is defined as L and is between 5 micrometers and 30 micrometers, and a diameter of the carbon nanotube 21 is defined as D and is between 1 nanometer and 30 nanometers. Further, an L/D value (also known as length-diameter ratio) of the carbon nanotube 21 is between 300 and 2,000.

It is worth mentioning that in this embodiment, when the plurality of carbon nanotubes 21 are dispersed in the polyester base material 1, the plurality of carbon nanotubes 21 are continuously dispersed in the polyester base material 1 and are in contact with each other, so as to form a plurality of contact points P in continuous distribution (as shown in FIG. 1). Therefore, the plurality of carbon nanotubes 21 can be connected with each other, so that the conductive polyester composition 100 can have a high conductive property and a low surface impedance. Specifically, the conductive polyester composition 100 has a surface impedance of not greater than 10⁷ Ω/sq.

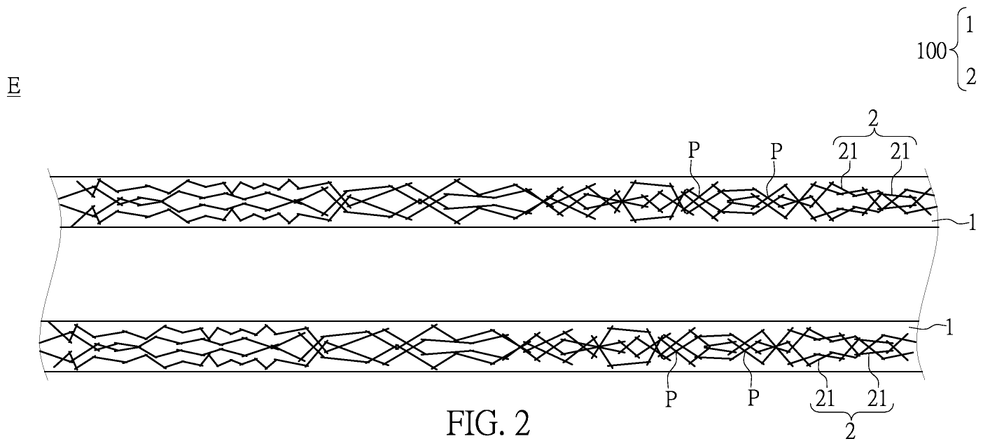

In one embodiment of the present disclosure, in order to maintain a high conductive property and a low surface impedance of the conductive polyester composition 100 after the extension, an exemplary range is set for the dimensions and specifications of the carbon nanotubes 21. Specifically, in each of the carbon nanotubes 21, the length L of the carbon nanotube 21 is preferably between 10 micrometers and 20 micrometers, the diameter D of the carbon nanotube 21 is preferably between 3 nanometers and 20 nanometers, and the L/D value of the carbon nanotube 21 is preferably between 1,000 and 2,000. In this embodiment, since the length L of the carbon nanotube 21 is long enough and the L/D value is high enough, the conductive polyester composition 100 can still have the plurality of contact points P in continuous distribution (as shown in FIG. 2) after the high-rate extension (e.g., a 200% to 400% extension), thereby having a high conductive property.

In terms of content range, based on the total weight of the conductive polyester composition 100, a content of the conductive reinforcing material 2 is preferably between 1.5 wt % and 10 wt %, and more preferably between 2 wt % and 5 wt %. That is to say, the conductive polyester composition 100 can obtain a high conductive property and a low surface impedance by having only a small addition (not greater than 10 wt %) of the plurality of carbon nanotubes 21 of the conductive reinforcing material 2.

If the content of the conductive reinforcing material 2 is below a lower limit of the aforementioned content range (e.g., below 1.5 wt %), the plurality of carbon nanotubes 21 cannot form enough contact points in the conductive polyester composition 100, and thus the conductive polyester composition 100 cannot obtain a high conductive property or a low surface impedance. On the contrary, if the content of the conductive reinforcing material 2 is above an upper limit of the aforementioned content range (e.g., above 10 wt %), the plurality of carbon nanotubes 21 may have a problem of poor dispersity in the conductive polyester composition 100, and problems including poor processability and extension difficulty may be present in the conductive polyester composition 100.

In terms of material type, the plurality of carbon nanotubes 21 can be at least one material selected from a group consisting of single-walled carbon nanotubes (SWCNT), double-walled carbon nanotubes (DWCNT) and multi-walled carbon nanotubes (MWCNT).

As shown in FIG. 3, in one embodiment of the present disclosure, the plurality of carbon nanotubes 21 are preferably multi-walled carbon nanotubes (MWCNT) having a multi-layer carbon atom structure. The advantage of using the multi-walled carbon nanotubes resides in that a low structural symmetry of the multi-walled carbon nanotubes facilitates surface modification, such that the compatibility and dispersity of the multi-walled carbon nanotube in a resin material can be improved. In addition, the structure of the multi-walled carbon nanotube is formed by rolling and stacking several to dozens of layers of concentric single-walled circular pipes, and is thus more suitable for extension. After the extension, problems such as breakage or structural damage are also less likely to occur. In practical application, since the conductive polyester composition 100 of this embodiment needs to undergo the high-rate extension, using the multi-walled carbon nanotubes allows a material to achieve a wide extensible range.

In one embodiment of the present disclosure, in order to improve the compatibility and dispersity of the conductive reinforcing material 2 in the polyester base material 1, the conductive polyester composition 100 further includes a compatibilizer (not illustrated in the figure). The compatibilizer is configured to assist in dispersing the plurality of carbon nanotubes 21 in the polyester base material 1.

In terms of content range, based on the total weight of the conductive polyester composition 100, a content of the compatibilizer is preferably between 1.5 wt % and 10 wt %, and more preferably between 2 wt % and 10 wt %.

In order to use the compatibilizer to effectively improve the dispersity of the carbon nanotubes 21 in the polyester base material 1, an exemplary weight ratio range is provided between the compatibilizer and the carbon nanotubes.

Specifically, the weight ratio range between the compatibilizer and the carbon nanotubes is between 2:1 and 1:1. For example, in the conductive polyester composition 100, the content of the compatibilizer can be 6 wt %, and a content of the carbon nanotubes can be 3 wt %. Or, for example, the content of the compatibilizer can be 3 wt %, and the content of the carbon nanotubes can be 3 wt %. From another perspective, the content of the compatibilizer is preferably at least not less than a content range of the carbon nanotubes, but the present disclosure is not limited thereto.

In one embodiment of the present disclosure, in order to improve the compatibility and dispersity of the conductive reinforcing material 2 in the polyester base material 1, the plurality of carbon nanotubes 21 of the conductive reinforcing material 2 are at least one material selected from a group consisting of hydroxylated carbon nanotubes and carboxylic carbon nanotubes. That is to say, the carbon nanotubes 21 are —OH modified or —COOH modified carbon nanotubes 21. Further, the compatibilizer is a polyolefin compatibilizer formed by grafting, modification or copolymerization of glycidyl methacrylate (GMA), or a siloxane compound.

According to the aforementioned configuration, the glycidyl methacrylate (GMA) in the molecular structure of the compatibilizer can carry out a ring cleavage reaction in a mixing modification process, and an epoxy group in the glycidyl methacrylate can carry out a chemical reaction (e.g., covalent bonding) with a reactive functional group on the surface of the carbon nanotube 21 and/or an ester group in the molecular structure of the polyester base material 1 after the ring cleavage reaction, so that the carbon nanotubes 21 are more compatible with the polyester base material 1 and are dispersed more uniformly in the polyester base material 1.

Here, the reactive functional group on the surface of the carbon nanotube 21 is at least one of an —OH functional group and a —COOH functional group. Further, the epoxy group in the glycidyl methacrylate can, for example, form covalent bonding with the reactive functional group on the surface of the carbon nanotube 21 and/or the ester group in the molecular structure of the polyester base material 1.

More specifically, in one embodiment of the present disclosure, the plurality of carbon nanotubes 21 of the conductive reinforcing material 2 are at least one material selected from a group consisting of hydroxylated multi-walled carbon nanotubes and carboxylic multi-walled carbon nanotubes, but the present disclosure is not limited thereto.

More specifically, in one embodiment of the present disclosure, the compatibilizer is at least one material selected from a group consisting of an ethylene-methyl acrylate-glycidyl methacrylate copolymer (E-MA-GMA), polyolefin elastomer-grafted glycidyl methacrylate (POE-g-GMA), polyethylene-grafted glycidyl methacrylate (PE-g-GMA) and a siloxane compound. Preferably, the compatibilizer is formed by combination of the ethylene-methyl acrylate-glycidyl methacrylate copolymer (E-MA-GMA) and the siloxane compound, but the present disclosure is not limited thereto.

It is worth mentioning that in the aforementioned compatibilizer, a molecular structure of the glycidyl methacrylate (hereinafter referred to as GMA) contains double reactive functional groups of a carbon-carbon double bond and an epoxy group. The GMA itself is a colorless transparent liquid insoluble in water and easily soluble in organic solvents. The GMA is an irritant to skin and mucosa, but is almost nontoxic. With double functional groups, the GMA can have a free radical type reaction as well as an ionic type reaction, and thus has a very high reactivity. Accordingly, the GMA can be widely applied in synthesis and improvement of polymer materials. For example, after grafting and modification of the GMA, polyolefin such as polyethylene (PE), polypropylene (PP) and polyethylene-octylene (POE) can significantly improve the bonding capacity and hydrophilicity of the polymer as well as its compatibility with a polymer resin.

In one embodiment of the present disclosure, in order to improve an antioxidant property of the conductive polyester composition 100, the conductive polyester composition 100 further includes an antioxidant. In terms of content range, based on the total weight of the conductive polyester composition 100, a content of the antioxidant is between 0.1 wt % and 1 wt %, but the present disclosure is not limited thereto.

In terms of material type, the antioxidant can be, for example, at least one material selected from a group consisting of a hindered phenol-based antioxidant, a phenol antioxidant, a mixed type antioxidant, a phosphite-based antioxidant and a composite antioxidant. Preferably, the antioxidant is a complex of the phosphite-based antioxidant, and the hindered phenol-based antioxidant.

In one embodiment of the present disclosure, in order to improve an overall degree of blackness of the conductive polyester composition 100, the conductive polyester composition 100 further includes black master batches. In terms of content range, based on the total weight of the conductive polyester composition 100, a content of the black master batches is between 1 wt % and 5 wt %, but the present disclosure is not limited thereto. The black master batches are added to control a hue of a conductive polyester material.

According to selection of the material type of the aforementioned conductive polyester composition 100 and adjustment of its content range, the conductive polyester composition 100 of this embodiment can be subjected to mixing modification of a twin-screw process, so that the conductive reinforcing material 2 can be uniformly dispersed in the polyester base material 1 and the conductive polyester composition 100 can have a high conductive property and a low surface resistance. It is worth mentioning that, after the mixing modification of the twin-screw process, the conductive polyester composition 100 has a surface impedance of not greater than 10⁷ Ω/sq.

More specifically, after the conductive polyester composition 100 is subjected to the mixing modification of the twin-screw process, the conductive layers A are formed and can be used for manufacturing electronic carrier tapes or electronic carrier trays.

According to the aforementioned configuration, the main structure supporting layer B and the two conductive layers A form a conductive polyester sheet material E of a sandwich structure by means of co-extrusion.

Further, the conductive polyester laminated structure can be extended through the vacuum forming process. Before the extension of the conductive polyester laminated structure E, a surface of each of the conductive layers A has a surface impedance of 10³ Ω/sq to 10⁴ Ω/sq. After the 200% to 400% extension of the conductive polyester laminated structure E along an extension direction (e.g., a transverse direction (TD) or a machine direction (MD)), each of the conductive layers A has a surface impedance of 10⁴ Ω/sq to 10⁷ Ω/sq. It is worth mentioning that, after each of the conductive layers A is extended, while a distribution density of the plurality of carbon nanotubes 21 becomes lower, the plurality of carbon nanotubes 21 are still in contact with each other and form the plurality of contact points P (as shown in FIG. 2), thereby are still capable of providing certain conductivity.

Before the extension of the conductive polyester laminated structure E, a thickness of the main structure supporting layer B is greater than a thickness of each of the conductive layers A.

Specifically, the thickness of the main structure supporting layer B is between 80 micrometers and 1,400 micrometers, preferably between 200 micrometers and 1,200 micrometers, and more preferably between 400 micrometers and 1,000 micrometers. The thickness of each of the conductive layers A is between 10 micrometers and 200 micrometers, preferably between 30 micrometers and 100 micrometers, and more preferably between 30 micrometers and 60 micrometers.

After the 200% to 400% extension of the conductive polyester laminated structure E along the extension direction, the thickness of the main structure supporting layer B and the thickness of each of the conductive layers will be reduced. Specifically, the thickness of the main structure supporting layer B is reduced to ½ to ¼ of its original thickness, and the thickness of each of the conductive layers A is also reduced to ½ to ¼ of its original thickness.

It is worth mentioning that, the thickness of the main structure supporting layer B must fall within the aforementioned thickness range for providing a proper support. If the thickness of the main structure supporting layer B is too small, sufficient support cannot be provided. On the other hand, if the thickness of the main structure supporting layer B is too large, an effect of vacuum forming will be affected. The thickness of the conductive layers A also must fall within the aforementioned thickness range for providing a proper conductive property. If the thickness of the conductive layers A is too small, the conductive layers A are easily damaged during the extension and can become non-conductive. If the thickness of the conductive layers A is too large, the carbon nanotubes are easily deposited at a bottom of the conductive layers A and thus cannot provide a sufficient conductive property.

### Second Embodiment

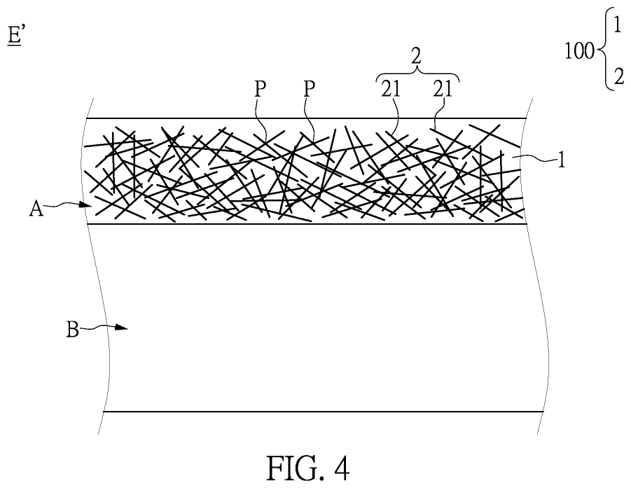

Referring to FIG. 4, a second embodiment of the present disclosure also provides a conductive polyester laminated structure E′. The structure and material features of the conductive polyester laminated structure E′ are substantially the same as those in the first embodiment, and their difference lies in that the conductive polyester laminated structure E′ of this embodiment is a double-layer laminated structure (rather than the sandwich structure).

Specifically, the conductive polyester laminated structure E′ of this embodiment includes a main structure supporting layer B and a conductive layer A. The main structure supporting layer B has two side surfaces located on opposite sides. The conductive layer A is formed on one of the side surfaces of the main structure supporting layer B.

The conductive layer A is formed of a conductive polyester composition 100. The conductive polyester composition 100 includes: a polyester base material 1 and a conductive reinforcing material 2. The conductive reinforcing material 2 includes a plurality of carbon nanotubes 21, and the plurality of carbon nanotubes 21 are dispersed in the polyester base material 1.

In each of the carbon nanotubes 21, a length of the carbon nanotube 21 is defined as L, a diameter of the carbon nanotube 21 is defined as D and is between 1 nanometer and 30 nanometers, and an L/D value of the carbon nanotube 21 is between 300 and 2,000. The plurality of carbon nanotubes 21 are in contact with each other to form a plurality of contact points P, so that a surface of the conductive layer A has a surface impedance of not greater than 10⁷ Ω/sq.

### Third Embodiment

A third embodiment of the present disclosure provides a conductive packaging material (not illustrated in the figure). The conductive packaging material is formed by extending the conductive polyester laminated structure E in the aforementioned first embodiment or second embodiment through the vacuum forming process. The conductive packaging material can be, for example, an electronic carrier tray or an electronic carrier tape.

### Experimental Data and Test Results

Hereinafter, a more detailed description will be provided with reference to Example 1 and Comparative examples 1 and 2. However, the examples below are only provided to aid in understanding of the present disclosure, and are not to be construed as limiting the scope of the present disclosure.

Example 1 provides a conductive polyester laminated structure having a sandwich structure (A-B-A). The formula of each layer is shown in Table 1 below. In the layer A-conductive layer, a polyester composition is added with 3 wt % of carbon nanotubes and 2 wt % of black master batches, and is made into a sheet conductive layer. In Example 1, the specifications of the carbon nanotubes are as follows: multi-walled carbon nanotubes, an average diameter of 5 nanometers to 15 nanometers, an average length of 10 micrometers to 20 micrometers, an L/D value of 1,000 to 2,000, a surface area of 200 m²/g to 300 m²/g, a purity of not less than 90%, and an overall density of 0.950 to 0.150. In the layer B-supporting layer, a polyester base material is formed of PET-3802 (a low-crystallinity polyester resin) provided by Nan Ya Plastics Corporation, and is added with 2 wt % of black master batches.

Test results of electrical performance of Example 1 show that the conductive layer has a surface resistance of 10³ Ω/sq to 10⁴ Ω/sq without an extension, has a surface resistance of 10⁴ Ω/sq to 10⁵ Ω/sq with a 200% extension, and has a surface resistance of 10⁶ Ω/sq to 10⁷ Ω/sq with a 400% extension. The aforementioned test results indicate that a small addition of the carbon nanotubes can achieve a high conductive property and a low surface resistance of the conductive layer. Further, even after a high-rate extension, the conductive layer of Example 1 still has a high conductive property.

Comparative example 1 is substantially the same as Example 1. A difference lies in that in Comparative example 1, the polyester composition is added with 25 wt % of a conductive graphite spherical material and is made into a conductive layer. Test results of electrical performance of Comparative example 1 show that the conductive layer has a surface resistance of about 10⁵ Ω/sq without the extension, has a surface resistance of about 10¹¹ Ω/sq with the 200% extension, and has a surface resistance of about 10¹¹ Ω/sq with the 400% extension. The aforementioned test results indicate that a large addition of the conductive graphite material is required to achieve a high conductive property of the conductive layer. However, after the high-rate extension, the conductive layer of Comparative example 1 does not have a high conductive property.

Comparative example 2 is substantially the same as Example 1. A difference lies in that in Comparative example 2, the polyester composition is added with 10 wt % of a conductive carbon black spherical material and is made into a conductive layer. Test results of electrical performance of Comparative example 2 show that the conductive layer has a surface resistance of about 10⁵ Ω/sq without the extension, has a surface resistance of about 10¹⁰ Ω/sq with the 200% extension, and has a surface resistance of about 10¹¹ Ω/sq with the 400% extension. The aforementioned test results indicate that a large addition of the conductive carbon black spherical material is required to achieve a high conductive property of the conductive layer. However, after the high-rate extension, the conductive layer of Comparative example 2 does not have a high conductive property.

A test method for the aforementioned surface resistance is to test a surface of the conductive layer of the conductive polyester laminated structure with a surface resistance tester.

Table 1 [Experimental data and test results]

| | | Comparative | Comparative |
|---|---|---|---|
| Formula/Test Results | Example 1 | Example 1 | Example 2 |
| Layer A-conductive | 3 wt % | 25 wt % of | 10 wt % of |
| layer (50 μm) | of carbon | conductive | conductive |
| | nanotubes | graphite | carbon black |
| Layer B-supporting | Low- | Low- | Low- |
| layer (450 μm) | crystallinity | crystallinity | crystallinity |
| | polyester resin | polyester resin | polyester resin |
| Surface resistance | 6*10³ Ω/sq | 10⁵ Ω/sq | 10⁵ Ω/sq |
| (without extension) | | | |
| Surface resistance | 10⁴ Ω/sq to | 10¹¹ Ω/sq | 10¹⁰ Ω/sq |
| (200% extension) | 10⁵ Ω/sq | | |
| Surface resistance | 10⁶ Ω/sq to | 10¹¹ Ω/sq | 10¹¹ Ω/sq |
| (400% extension) | 10⁷ Ω/sq | | |

### Beneficial Effects of the Embodiments

In conclusion, in the conductive polyester laminated structure and the conductive packaging material provided by the present disclosure, by virtue of “the conductive reinforcing material including a plurality of carbon nanotubes, and the plurality of carbon nanotubes being dispersed in the polyester base material,” “in each of the carbon nanotubes, a length of the carbon nanotube being defined as L, a diameter of the carbon nanotube being defined as D and being between 1 nanometer and 30 nanometers, and an L/D value of the carbon nanotube being between 300 and 2,000,” and “the plurality of carbon nanotubes being in contact with each other to form a plurality of contact points, so that the conductive polyester composition has a surface impedance of not greater than 10⁷ Ω/sq,” the conductive polyester composition can still have a high conductive property with a small addition of the conductive reinforcing material, and the conductive polyester laminated structure can still have a high conductive property after a high-rate extension.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A conductive polyester laminated structure, comprising:
a main structure supporting layer having two side surfaces located on opposite sides thereof; and
two conductive layers respectively formed on the two side surfaces of the main structure supporting layer, wherein each of the conductive layers is formed of a conductive polyester composition; wherein in each of the conductive layers, the conductive polyester composition includes:
a polyester base material; and
a conductive reinforcing material, wherein the conductive reinforcing material includes a plurality of carbon nanotubes, and the plurality of carbon nanotubes are dispersed in the polyester base material; wherein in each of the carbon nanotubes, a length of the carbon nanotube is defined as L, a diameter of the carbon nanotube is defined as D and is between 1 nanometer and 30 nanometers, and an L/D value of the carbon nanotube is between 300 and 2,000; wherein the plurality of carbon nanotubes are in contact with each other to form a plurality of contact points, so that a surface of the conductive layer has a surface impedance of not greater than 10⁷ Ω/sq.

2. The conductive polyester laminated structure according to claim 1, wherein the main structure supporting layer is formed of a polymer resin material and configured to provide an overall impact strength of not less than 4.2 KJ/m² for the conductive polyester laminated structure.

3. The conductive polyester laminated structure according to claim 2, wherein the polymer resin material is a polyester resin material, and the polyester resin material is an isophthalic acid (IPA) modified copolyester and has a low degree of crystallinity; wherein, based on a total weight of the polyester resin material, a content of the IPA is between 1 wt % and 10 wt %.

4. The conductive polyester laminated structure according to claim 1, wherein the main structure supporting layer and the two conductive layers are formed into a conductive polyester sheet material having a sandwich structure by co-extrusion.

5. The conductive polyester laminated structure according to claim 1, wherein a thickness of the main structure supporting layer is greater than a thickness of each of the conductive layers, the thickness of the main structure supporting layer is between 80 micrometers and 1,400 micrometers, and the thickness of each of the conductive layers is between 10 micrometers and 200 micrometers.

6. The conductive polyester laminated structure according to claim 1, wherein in each of the carbon nanotubes, the length is between 10 micrometers and 20 micrometers, the diameter is between 5 nanometers and 20 nanometers, and the L/D value is between 1,000 and 2,000.

7. The conductive polyester laminated structure according to claim 1, wherein, based on a total weight of the conductive polyester composition, a content of the polyester base material is between 70 wt % and 95 wt %, and a content of the conductive reinforcing material is between 1.5 wt % and 10 wt %.

8. The conductive polyester laminated structure according to claim 1, wherein the plurality of carbon nanotubes of the conductive reinforcing material are multi-walled carbon nanotubes (MWCNT) having a multi-layer carbon atom structure.

9. The conductive polyester laminated structure according to claim 1, wherein the conductive polyester composition further includes a compatibilizer configured to assist in dispersing the plurality of carbon nanotubes in the polyester base material; wherein, based on a total weight of the conductive polyester composition, a content of the compatibilizer is between 1.5 wt % and 10 wt %.

The conductive polyester laminated structure according to claim 9, wherein the plurality of carbon nanotubes of the conductive reinforcing material are at least one material selected from a group consisting of hydroxylated carbon nanotubes and carboxylic carbon nanotubes; wherein the compatibilizer is a polyolefin compatibilizer formed by grafting, modification or copolymerization of glycidyl methacrylate (GMA), or a siloxane compound.

11. The conductive polyester laminated structure according to claim 10, wherein the glycidyl methacrylate in a molecular structure of the compatibilizer is capable of carrying out a ring cleavage reaction in a mixing process, and an epoxy group in the glycidyl methacrylate is capable of carrying out a chemical reaction with a reactive functional group on a surface of the carbon nanotube and/or an ester group in a molecular structure of the polyester base material after the ring cleavage reaction, so that the carbon nanotubes are dispersed in the polyester base material; wherein the reactive functional group on the surface of the carbon nanotube is at least one of an —OH functional group and a —COOH functional group.

12. The conductive polyester laminated structure according to claim 10, wherein the plurality of carbon nanotubes of the conductive reinforcing material are at least one material selected from a group consisting of hydroxylated multi-walled carbon nanotubes and carboxylic multi-walled carbon nanotubes.

13. The conductive polyester laminated structure according to claim 10, wherein the compatibilizer is at least one material selected from a group consisting of an ethylene-methyl acrylate-glycidyl methacrylate copolymer (E-MA-GMA), polyolefin elastomer-grafted glycidyl methacrylate (POE-g-GMA), polyethylene-grafted glycidyl methacrylate (PE-g-GMA) and a siloxane compound.

14. The conductive polyester laminated structure according to claim 10, wherein the conductive polyester composition further includes: an antioxidant and black master batches; wherein, based on a total weight of the conductive polyester composition, a content of the antioxidant is between 0.1 wt % and 1 wt %, and a content of the black master batches is between 1 wt % and 5 wt %.

15. The conductive polyester laminated structure according to claim 1, wherein the conductive polyester composition of each of the conductive layers is configured to be subjected to mixing modification of a twin-screw process.

16. The conductive polyester laminated structure according to claim 15, wherein the conductive polyester laminated structure is capable of being extended through a vacuum forming process; wherein, before an extension of the conductive polyester laminated structure, the surface of each of the conductive layers has a surface impedance of 10³ Ω/sq to 10⁴ Ω/sq; wherein, after a 200% to 400% extension of the conductive polyester laminated structure along an extension direction, the surface of each of the conductive layers has a surface impedance of 10⁴ Ω/sq to 10⁷ Ω/sq.

17. A conductive polyester laminated structure, comprising:
a main structure supporting layer having two side surfaces located on opposite sides thereof; and
a conductive layer formed on one of the side surfaces of the main structure supporting layer, wherein the conductive layer is formed of a conductive polyester composition, and the conductive polyester composition includes:
a polyester base material; and
a conductive reinforcing material, wherein the conductive reinforcing material includes a plurality of carbon nanotubes, and the plurality of carbon nanotubes are dispersed in the polyester base material, wherein in each of the carbon nanotubes, a length of the carbon nanotube is defined as L, a diameter of the carbon nanotube is defined as D and is between 1 nanometer and 30 nanometers, and an L/D value of the carbon nanotube is between 300 and 2,000; wherein the plurality of carbon nanotubes are in contact with each other to form a plurality of contact points, so that a surface of the conductive layer has a surface impedance of not greater than 10⁷ Ω/sq.

18. A conductive packaging material, characterized in that the conductive packaging material is formed by extending the conductive polyester laminated structure as claimed in claim 1 through a vacuum forming process.
